(19) United States
(12) Patent Application Publication
(10) Pub. No.: US 2024/0103122 A1
(43) Pub. Date: Mar. 28, 2024

(54) DISTANCE MEASUREMENT METHOD, ELECTRONIC DEVICE AND STORAGE MEDIUM

(71) Applicants: Fu Tai Hua Industry (Shenzhen) Co., Ltd., Shenzhen (CN); HON HAI PRECISION INDUSTRY CO., LTD., New Taipei (TW)

(72) Inventor: WEN-HUI HUANG, Shenzhen (CN)

(21) Appl. No.: 17/988,620

(22) Filed: Nov. 16, 2022

(30) Foreign Application Priority Data
Sep. 27, 2022 (CN) 202211185552.5

(51) Int. Cl. G01S 5/18; G02B 27/01; G06F 3/01

(52) U.S. Cl. CPC G01S 5/18; G02B 27/017; G06F 3/013; G02B 2027/0178

(57) ABSTRACT

A distance measurement method is provided and includes: in response to a distance detection instruction, determining a first position where a pupil of a user is located. An included angle between the pupil and an electronic device is determined based on the first position and a second position where the electronic device is located. Once a first distance between the pupil and the electronic device is determined, a second distance between a waveguide sheet in a pair of smart glasses worn by the user and the pupil is calculated according to the included angle and the first distance.

### FIELD

The subject matter relates to a field of distance measurement, and in particular, to a distance measurement method, an electronic device, and a storage medium.

### BACKGROUND

Augmented reality (AR) and virtual reality (VR) are the technology fields that have received wide attention in recent years. A near-eye display system based on AR or VR technology uses a series of optical imaging elements to form a distant virtual image of pixels on a display and projects the distant virtual image into a human eye. For example, a display system used in AR glasses or VR glasses on the market is a combination of optical imaging elements such as various micro-displays and waveguide sheets. Micro-displays are used to display content for AR glasses or VR glasses. After the micro-display completes an imaging process, the waveguide sheet couples a light corresponding to the imaging into its own glass substrate, and transmits and releases the light to the front of the human eye through the principle of “total reflection”.

A position of the waveguide sheet installed in the AR glasses or VR glasses is very important. When wearing the AR glasses or VR glasses, the distance from the waveguide sheet to a pupil of the user affects the user's viewing effect of the AR glasses or VR glasses. Since the waveguide sheet may not be accurately installed in a preset position during an assembly process, after the AR glasses or VR glasses is assembled, the distance from the waveguide sheet to the user's pupil needs to be tested, and the position of the waveguide sheet should be adjusted according to the distance. At present, for the user wearing the AR glasses or VR glasses, measuring tools such as a ruler are usually used to determine the distance from the waveguide sheet to the user's pupil. Measured distance may not accurate enough using the above described method, and large errors are prone to occur, thus affecting what the user sees in the AR glasses or VR glasses.

### BRIEF DESCRIPTION OF THE DRAWINGS

FIG. 1 is a schematic flowchart of a distance measurement method provided by an embodiment of the present disclosure.

FIG. 2 is a schematic diagram of a target plane provided by an embodiment of the present disclosure.

FIG. 3 is a schematic diagram of a third position provided by an embodiment of the present disclosure.

FIG. 4 is a schematic structural diagram of a distance measurement device provided by an embodiment of the present disclosure.

FIG. 5 is a schematic structural diagram of an electronic device implementing the distance measurement method provided by an embodiment of the present disclosure.

### DETAILED DESCRIPTION

Hereinafter, the terms “first” and “second” are only used for purposes of description, and should not be construed as indicating or implying relative importance or implicitly indicating the number of indicated technical features. Thus, a feature defined as “first” or “second” may expressly or implicitly include one or more of that feature. In the description of the embodiments of the present disclosure, words such as “exemplary”, “or”, “for example” and the like are used to mean serving as an example, or illustration. Any embodiment or design described in the embodiments of the present disclosure as “exemplary” or “such as” should not be construed as being preferred or advantageous over other embodiments or designs. Rather, use of the words “exemplary,” “or”, “e.g.,” and the like is intended to present the related concepts in a specific manner.

Unless otherwise defined, all technical and scientific terms used herein have the same meaning as commonly understood by one of ordinary skill in the art pertaining to this disclosure. The terms used in the description of the present disclosure are for the purpose of describing specific embodiments only, and are not intended to limit the present disclosure. It should be understood that, unless otherwise specified in this disclosure, “/” means “or”. For example, “A/B” can mean A or B. In the present disclosure, “and/or” is only an association relationship to describe associated objects, which means that there can be three kinds of relationships. For example, A and/or B can mean that A exists alone, that A and B exist at the same time, and that B exists alone. “At least one” means one or more. “a plurality of” means two or more. For example, “at least one of a, b, or c” can represent seven situations including: a; b; c; a and b; a and c; b and c; and a, b and c. It should be understood that an order of blocks shown in the flowchart herein may be changed and some may be omitted.

Augmented reality (AR) and virtual reality (VR) are the technology fields that have received wide attention in recent years. The near-eye display system based on AR and VR technology uses a series of optical imaging elements to form a distant virtual image of pixels on a display and projects the distant virtual image into a human eye. For example, a display system used in AR glasses or VR glasses on the market is a combination of optical imaging elements such as various micro-displays and waveguide sheets. Micro-displays are used to display content for AR glasses or VR glasses. After the micro-display completes an imaging process, the waveguide sheet couples a light corresponding to imaging into its own glass substrate, and transmits and releases the light to the front of the human eye through the principle of “total reflection”.

A position of the waveguide sheet installed in the AR glasses or VR glasses is very important. After a user wears the AR glasses or VR glasses, a distance from the waveguide sheet to a pupil of the user affects the user's viewing effect of the AR glasses or VR glasses. Since the waveguide sheet may not be accurately installed in a preset position during an assembly process, after the AR glasses or VR glasses is assembled, the distance from the waveguide sheet to the user's pupil needs to be tested, and the position of the waveguide sheet should adjusted according to the distance. However, at present, after the user wears AR glasses or VR glasses, measuring tools such as a ruler are usually used to determine the distance from the waveguide sheet to the user's pupil, so the measured distance is not accurate enough, and large errors are prone to occur. For the convenience of description below, AR glasses and VR glasses are collectively referred to as smart glasses.

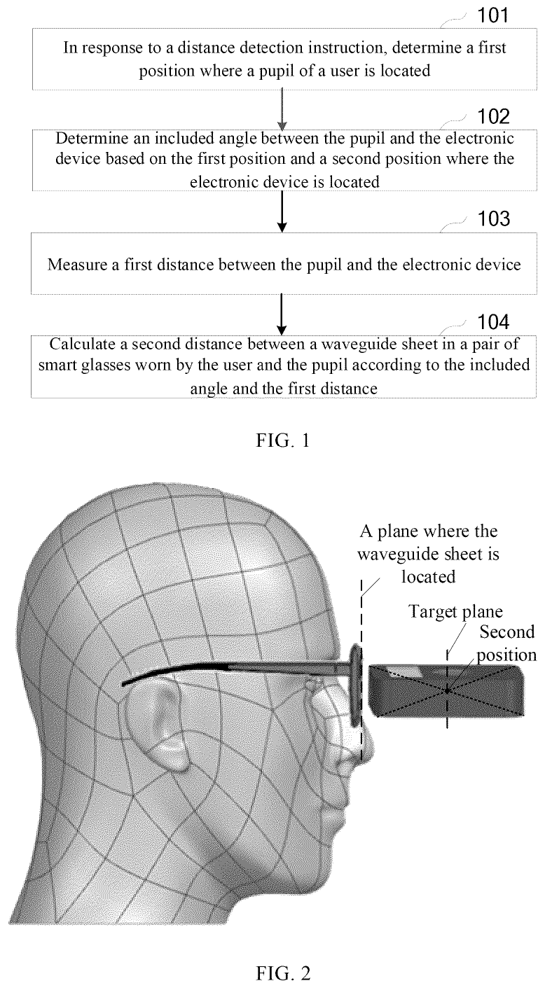

In order to solve the issue that the measurement error of the distance between the waveguide sheet and the user's pupil is large in smart glasses, an embodiment of the present disclosure provides a distance measurement method. The method is used to measure the distance between the waveguide sheet in the smart glasses and the user's pupil. An accuracy of measuring the distance between the waveguide sheet and the user's pupil can be improved. FIG. 1 is a schematic flowchart of a distance measurement method according to an embodiment of the present disclosure. The distance measurement method is applied to an electronic device. Exemplarily, the electronic device in the embodiment of the present disclosure may be a mobile phone, a tablet computer, a desktop computer, a laptop computer, a handheld computer, a notebook computer, an ultra-mobile personal computer (UMPC), a netbook, and electronic devices such as cellular phones, personal digital assistants (PDAs), artificial intelligence (AI) devices, wearable devices, in-vehicle devices, smart home devices and/or smart city devices. The embodiments of the present disclosure do not specifically limit the type of the electronic device. The network in which the electronic device is located includes, but is not limited to, the Internet, a wide area network, a metropolitan area network, a local area network, a virtual private network (VPN), and the like.

In order to make the objectives, technical solutions and advantages of the distance measurement method provided by the embodiments of the present disclosure more clear, the distance measurement method is described in detail below with reference to the accompanying drawings and specific embodiments. FIG. 1 is a flowchart of a distance measurement method provided by an embodiment of the present disclosure. According to different requirements, the order of the blocks in this flowchart can be changed, and some blocks can be omitted. As shown in FIG. 1, the method includes:

In some embodiments of the present disclosure, when the distance between the waveguide sheet in the smart glasses and the pupil needs to be measured, the user may wear the smart glasses which include the waveguide sheet. The user holds the electronic device and brings the electronic device close to the smart glasses to trigger the distance measurement. For example, after the user moves the electronic device to bring the electronic device closer to the smart glasses, the user can press a preset button/key on the electronic device to trigger a distance measurement instruction to measure the distance between the waveguide sheet in the smart glasses and the pupil. For another example, after the user moves the electronic device and brings the electronic device closer to the smart glasses, an end of the smart glasses close to the electronic device is provided with a sensor for sensing the distance between the electronic device and the waveguide sheet (or smart glasses). When the distance between the electronic device and the waveguide sheet (or smart glasses) is less than or equal to the preset distance threshold, the sensor triggers a distance detection instruction.

101. In response to a distance detection instruction, the electronic device determines a first position where the pupil of the user is located. The electronic device can preset a distance according to an actual situation, which is not limited here. When a distance between the electronic device and the waveguide sheet is less than the preset distance, the distance between the electronic device and the waveguide sheet is very small, and can be ignored.

For example, a point is used to represent the pupil of an eye, and the position of the point is the first position, and the pupil can be represented by a center point of the pupil. In some embodiments of the present disclosure, the electronic device can capture an image of eye (eye image) of the user, and determine the first position where the pupil is located based on the eye image.

In some embodiments of the present disclosure, the electronic device includes a photographing device for acquiring the eye image of the user. The position of the center point corresponding to the pupil in the eye image may be used to determine the first position where the pupil is located.

It can be understood that the above-mentioned method for determining the eye image by the electronic device is only an example. In practical applications, other eye tracking methods can be used to track the eye movement and determine the first position of the pupil.

102. The electronic device determines an included angle between the pupil and the electronic device based on the first position and a second position where the electronic device is located.

The electronic device determines the position where the electronic device is located as the second position. The electronic device can use a point to represent the electronic device, and the position of the point is the second position. For example, a center point of the electronic device may be determined as the point representing the electronic device, and the position of the center point of the electronic device may be determined as the second position.

In some embodiments of the present disclosure, the determining of the included angle between the pupil and the electronic device based on the first position and the second position includes:
Determining a first connection line according to the first position and the second position;
Determining a target plane according to a plane where the waveguide sheet is located and the second position, wherein the plane where the waveguide sheet is located is parallel to the target plane and the second position is located on the target plane; and
Determining an included angle between the first connection line and the target plane as the included angle between the pupil and the electronic device.

Two points can be connected to form a line. The electronic device can obtain a first line by connecting the first position and the second position. The electronic device can determine a plane including the second position and being parallel to the plane on which the waveguide sheet is located as the target plane. FIG. 2 is a schematic diagram of a target plane according to an embodiment of the present disclosure. As shown in FIG. 2, the target plane is parallel to the plane on which the waveguide sheet is located, and the second position is on the target plane. It can be understood that, in order to better illustrate the plane on which the waveguide sheet is located and better illustrate the target plane, the waveguide sheet is far away from the electronic device in FIG. 2. In practical applications, the electronic device is generally close to the waveguide sheet. The distance between the waveguide sheet and the electronic device is very small and can be ignored.

103. The electronic device measures a first distance between the pupil and the electronic device.

In some embodiments of the present disclosure, the electronic device includes an ultrasonic sensor, and the ultrasonic sensor is used to measure distance based on ultrasonic waves, and can transmit ultrasonic signals and receive returned ultrasonic signals. The measuring the first distance between the pupil and the electronic device includes: measuring the first distance between the pupil and the electronic device based on ultrasonic waves. Ultrasonic wave has a function of using the returned ultrasonic signal for distance measurement. Since the electronic device is close to the waveguide sheet, the ultrasonic signal reflected by the electronic device can penetrate the waveguide sheet and return after encountering the user's pupil. The electronic device can calculate the first distance between the pupil and the electronic device according to the returned ultrasonic signals.

It can be understood that the above-mentioned distance measurement based on ultrasonic signals is only for illustration, and in practical applications, other distance measurement methods can also be used, and the method for measuring the first distance is not limited here.

104. The electronic device calculates a second distance between the waveguide sheet in the smart glasses worn by the user and the pupil according to the included angle and the first distance.

The electronic device determines the first distance as the distance between the second location and the pupil.

In some embodiments of the present disclosure, the calculating of the second distance between the waveguide sheet in the smart glasses worn by the user and the pupil according to the included angle and the first distance includes:
Determining a third position closest to the first position on the target plane;
Determining a second connection line according to the first position and the third position; Calculating a length of the second connection line according to the included angle and the first distance, and determining the length of the second connection line as the second distance between the waveguide sheet and the pupil.

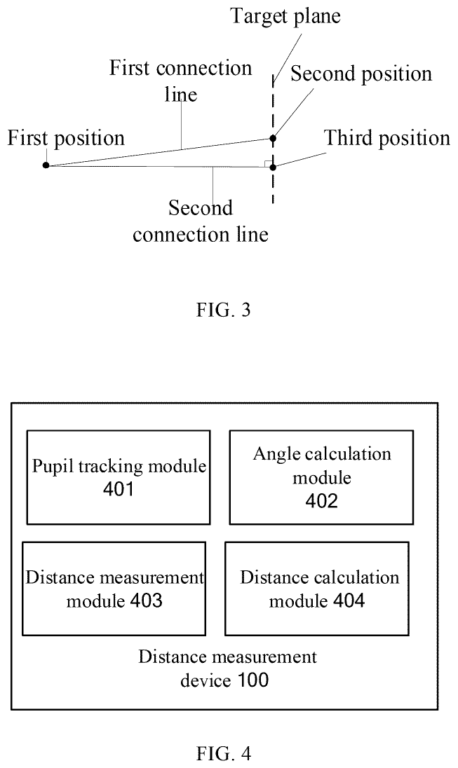

In the disclosed embodiment, the electronic device determines a vertical projection point of a point (for example, the center point of the pupil) at the first position on the target plane as a closest point to the first position on the target plane; and determines a position of the vertical projection point as the third position. FIG. 3 is a schematic diagram of the third position according to an embodiment of the present disclosure. As shown in FIG. 3, the first position and the third position are connected to obtain a second connection line, and the second connection line is perpendicular to the target plane. According to the included angle between the target plane and the first connection line and the length of the first connection line, the length of the second connection line can be calculated. For example, the electronic device can use the Pythagorean theorem to calculate the length of the second connection.

The distance measurement method provided by the above embodiments can accurately measure the distance between the waveguide sheet in the smart glasses and the pupil, thereby improving the accuracy of measuring the distance between the waveguide sheet and the pupil.

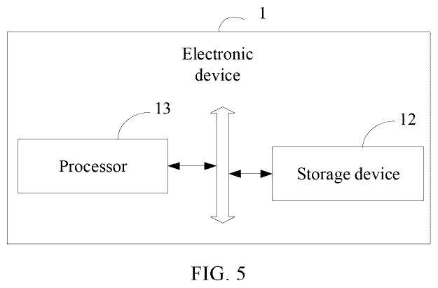

FIG. 4 provides a distance measuring device according to an embodiment of the present disclosure, so as to improve the accuracy of measuring the distance from the waveguide sheet to the user's pupil. FIG. 4 is a schematic structural diagram of a distance measuring device according to an embodiment of the disclosure. As shown in FIG. 4, the distance measurement device 100 includes a pupil tracking module 401, an angle calculation module 402, a distance measurement module 403, and a distance calculation module 404. The modules/units mentioned in the embodiments of the present disclosure refer to a series of computer-readable instruction segments (e.g., program codes) that can be acquired by a processor of an electronic device (such as an electronic device 1 as shown in FIG. 5) and can perform fixed functions, and are stored in a storage device (such as a storage device 12 as shown in FIG. 5). In this embodiment, the functions of each module/unit will be described in detail in subsequent embodiments.

In response to a distance detection instruction, the pupil tracking module 401 determines a first position where the pupil of the user is located. The pupil tracking module 401 can preset a distance according to an actual situation, which is not limited here. When a distance between the electronic device and the waveguide sheet is less than the preset distance, the distance between the electronic device and the waveguide sheet is very small, and can be ignored.

For example, a point is used to represent the pupil, and the position of the point is the first position, and the pupil can be represented by a center point of the pupil. In some embodiments of the present disclosure, the pupil tracking module 401 can capture an eye image of the user, and determine the first position where the pupil is located based on the eye image.

In some embodiments of the present disclosure, the electronic device includes a photographing device for acquiring the eye image of the user. The position of the center point corresponding to the pupil in the eye image may be used to determine the first position where the pupil is located.

It can be understood that the above-mentioned method for determining the eye image is only an example. In practical applications, other eye tracking methods can be used to track the eye movement and determine the first position of the pupil.

The angle calculation module 402 determines an included angle between the pupil and the electronic device based on the first position and a second position where the electronic device is located.

The angle calculation module 402 determines the position where the electronic device is located as the second position. The angle calculation module 402 can use a point to represent the electronic device, and the position of the point is the second position. For example, a center point of the electronic device may be determined as the point representing the electronic device, and the position of the center point of the electronic device may be determined as the second position.

In some embodiments of the present disclosure, the determining of the included angle between the pupil and the electronic device based on the first position and the second position includes:
Determining a first connection line according to the first position and the second position;
Determining a target plane according to a plane where the waveguide sheet is located and the second position, wherein the plane where the waveguide sheet is located is parallel to the target plane and the second position is located on the target plane; and
Determining an included angle between the first connection line and the target plane as the included angle between the pupil and the electronic device.

Two points can be connected to form a line. The angle calculation module 402 can obtain a first line by connecting the first position and the second position. The angle calculation module 402 can determine a plane including the second position and being parallel to the plane on which the waveguide sheet is located as the target plane. FIG. 2 is a schematic diagram of a target plane according to an embodiment of the present disclosure. As shown in FIG. 2, the target plane is parallel to the plane where the waveguide sheet is located, and the second position is on the target plane. It can be understood that, in order to better illustrate the plane on which the waveguide sheet is located and better illustrate the target plane, the waveguide sheet is far away from the electronic device in FIG. 2. In practical applications, the electronic device is generally close to the waveguide sheet. The distance between the waveguide sheet and the electronic device is very small and can be ignored.

The distance measurement module 403 measures a first distance between the pupil and the electronic device.

In some embodiments of the present disclosure, the electronic device includes an ultrasonic sensor, and the ultrasonic sensor is used to measure distance based on ultrasonic waves, and can transmit ultrasonic signals and receive returned ultrasonic signals. The measuring the first distance between the pupil and the electronic device includes: measuring the first distance between the pupil and the electronic device based on ultrasonic waves. Ultrasonic wave has a function of using the returned ultrasonic signal for distance measurement. Since the electronic device is close to the waveguide sheet, the ultrasonic signal reflected by the electronic device can penetrate the waveguide sheet and return after encountering the user's pupil. The distance measurement module 403 can calculate the first distance between the pupil and the electronic device according to the returned ultrasonic signals.

It can be understood that the above-mentioned distance measurement based on ultrasonic signals is only for illustration, and in practical applications, other distance measurement methods can also be used, and the method for measuring the first distance is not limited here.

The distance calculation module 404 calculates a second distance between the waveguide sheet in the smart glasses worn by the user and the pupil according to the included angle and the first distance.

The distance calculation module 404 determines the first distance as the distance between the second location and the pupil.

In some embodiments of the present disclosure, the calculating of the second distance between the waveguide sheet in the smart glasses worn by the user and the pupil according to the included angle and the first distance includes:
Determining a third position closest to the first position on the target plane;
Determining a second connection line according to the first position and the third position;
Calculating a length of the second connection line according to the included angle and the first distance, and determining the length of the second connection line as the second distance between the waveguide sheet and the pupil.

In the disclosed embodiment, the distance calculation module 404 determines a vertical projection point of a point (for example, the center point of the pupil) at the first position on the target plane as a closest point to the first position on the target plane; and determines a position of the vertical projection point as the third position. FIG. 3 is a schematic diagram of the third position according to an embodiment of the present disclosure. As shown in FIG. 3, the first position and the third position are connected to obtain a second connection line, and the second connection line is perpendicular to the target plane. According to the included angle between the target plane and the first connection line and the length of the first connection line, the length of the second connection line can be calculated. For example, the distance calculation module 404 can use the Pythagorean theorem to calculate the length of the second connection.

The distance measurement device provided by the above embodiments can accurately measure the distance between the waveguide sheet in the smart glasses and the pupil, thereby improving the accuracy of measuring the distance between the waveguide sheet and the pupil.

As shown in FIG. 5, it is a schematic structural diagram of an electronic device implementing the distance measurement method of the present disclosure.

In an embodiment of the present disclosure, the electronic device 1 includes, but is not limited to, a storage device 12, a processor 13, and one or more computer programs stored in the storage device 12 and can be executed by the processor 13. For example, the computer program can be a program of distance measurement.

Those skilled in the art can understand that the schematic structural diagram is only an example of the electronic device 1, and does not constitute a limitation on the electronic device 1, and may include more or less components than the one shown, or combine some components, or different components, for example, the electronic device 1 may also include input and output devices, network access devices, buses, and the like.

The processor 13 may be a central processing unit (CPU), or other general-purpose processors, a digital signal processor (DSP), an application specific integrated circuit (ASIC), Field-Programmable Gate Array (FPGA) or other programmable logic devices, discrete gate or transistor logic devices, discrete hardware components, etc. The general-purpose processor can be a microprocessor or the processor can also be any conventional processor, etc. The processor 13 is the computing core and control center of the electronic device 1, and uses various interfaces and lines to connect each part of the electronic device. 1. The processor 13 executes the operating system of the electronic device 1 and executes various installed applications, program codes, computer-readable instructions of the electronic device 1.

The storage device 12 can be used to store the computer programs and/or modules, and the processor 13 executes the computer programs and/or modules stored in the storage device 12, and calls the data stored in the storage device 12, such that various functions of the electronic device 1 are realized. The storage device 12 may mainly include an area for storing programs and an area for storing data, wherein the area for storing programs may store an operating system, an application program required for at least one function (such as a sound playback function, an image playback function, etc.), and the like; the area for storing data may store the data created according to the use of the electronic device 1. In addition, the storage device 12 may include non-volatile storage device such as hard disk, internal memory, plug-in hard disk, smart media card (SMC), Secure digital (SD) card, flash card, at least one disk storage device, flash memory device, or other non-volatile solid state storage device.

Exemplarily, the computer program may be divided into one or more modules/units, and the one or more modules/units are stored in the storage device 12 and executed by the processor 13 to complete the disclosed embodiment. The one or more modules/units may be a series of computer-readable instruction segments capable of accomplishing specific functions, and the computer-readable instruction segments are used to describe the execution process of the computer-readable instructions in the electronic device 1. For example, the computer program may be divided into the pupil tracking module 401, the angle calculation module 402, the distance measurement module 403 and the distance calculation module 404 as shown in FIG. 4.

The storage device 12 may be an external storage device and/or an internal storage device of the electronic device 1. Further, the storage device 12 may be a storage in physical form, such as a memory stick, a trans-flash card, and the like.

If the modules/units integrated in the electronic device 1 are implemented in the form of software functional units and sold or used as independent products, they may be stored in a computer-readable storage medium. Based on this understanding, the present disclosure can implement all or part of the processes in the methods of the above embodiments, and can also be completed by instructing the relevant hardware through a computer program. The computer program can be stored in a computer-readable storage medium, and when the computer program is executed by the processor, the blocks of the foregoing method embodiments can be implemented.

Wherein, the computer program includes computer program code, and the computer program code may be in the form of source code, object code, obtainable file or some intermediate form, and the like. The computer-readable medium may include: any entity or device capable of carrying the computer program code, recording medium, U disk, removable hard disk, magnetic disk, optical disk, computer memory, read-only memory (ROM).

With reference to FIG. 1, the storage device 12 in the electronic device 1 stores a plurality of instructions to implement the distance measurement method, and the processor 13 can execute the plurality of instructions to implement:
When the distance between the electronic device and the waveguide sheet is less than a preset distance, determining a first position where the pupil of the user is located;
Determining an angle between the pupil and the electronic device based on the first position and a second position where the electronic device is located;
Measuring a first distance between the pupil and the electronic device;
Calculating a second distance between the waveguide sheet and the pupil according to the included angle and the first distance.

Specifically, for the specific implementation method of the above-mentioned instruction by the processor 13, reference may be made to the description of the relevant blocks in the corresponding embodiment of FIG. 1, and details are not described herein.

In the several embodiments provided in this disclosure, it should be understood that the devices and methods disclosed can be implemented by other means. For example, the device embodiments described above are only schematic. For example, the division of the modules is only a logical function division, which can be implemented in another way.

The computer-readable storage medium stores computer-readable instructions, wherein the computer-readable instructions are used to implement the following processes when executed by the processor 13:
When the distance between the electronic device and the waveguide sheet is less than a preset distance, determine a first position where the pupil of the user is located;
Determining an angle between the pupil and the electronic device based on the first position and a second position where the electronic device is located;
Measuring a first distance between the pupil and the electronic device;
Calculating a second distance between the waveguide sheet and the pupil according to the included angle and the first distance.

The modules described as separate parts may or may not be physically separate, and the parts displayed as modules may or may not be physical units, that is, may be located in one place, or may be distributed over multiple network units. Part or all of the modules can be selected according to the actual needs to achieve the purpose of this embodiment.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

The above integrated modules implemented in the form of function modules may be stored in a storage medium. The above function modules may be stored in a storage medium, and include several instructions to enable a computing device (which may be a personal computer, server, or network device, etc.) or processor to execute the method described in the embodiment of the present disclosure.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names but not to signify any particular order.

The above description is only embodiments of the present disclosure and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A distance measurement method applied to an electronic device, the method comprising:
in response to a distance detection instruction, determining a first position where a pupil of a user is located;
determining an included angle between the pupil and the electronic device based on the first position and a second position where the electronic device is located;
measuring a first distance between the pupil and the electronic device; and
calculating a second distance between a waveguide sheet in a pair of smart glasses worn by the user and the pupil according to the included angle and the first distance.

2. The distance measurement method according to claim 1, wherein the determining of the included angle comprises:
determining a first connection line according to the first position and the second position;
determining a target plane according to a plane where the waveguide sheet is located and the second position, wherein the plane where the waveguide sheet is located is parallel to the target plane and the second position is located on the target plane; and
determining an included angle between the first connection line and the target plane as the included angle between the pupil and the electronic device.

3. The distance measurement method according to claim 2, wherein the calculating of the second distance comprises:
determining a third position closest to the first position on the target plane;
determining a second connection line according to the first position and the third position; and
calculating a length of the second connection line according to the included angle and the first distance, and determining the length of the second connection line as the second distance between the waveguide sheet and the pupil.

4. The distance measurement method according to claim 1, wherein the determining of the first position comprises:
capturing an eye image of the user; and
determining the first position where the pupil is located based on the eye image.

5. The distance measurement method according to claim 1, wherein the measuring of the first distance comprises:
measuring the first distance based on ultrasonic waves.

6. An electronic device comprising:
a storage device; and
at least one processor;
the storage device storing one or more programs, which when executed by the at least one processor, cause the at least one processor to:
in response to a distance detection instruction, determine a first position where a pupil of a user is located;
determine an included angle between the pupil and the electronic device based on the first position and a second position where the electronic device is located;
measure a first distance between the pupil and the electronic device;
calculate a second distance between a waveguide sheet in a pair of smart glasses worn by the user and the pupil according to the included angle and the first distance.

7. The electronic device according to claim 6, wherein the at least one processor determines the included angle by:
determining a first connection line according to the first position and the second position;
determining a target plane according to a plane where the waveguide sheet is located and the second position, wherein the plane where the waveguide sheet is located is parallel to the target plane and the second position is located on the target plane; and
determining an included angle between the first connection line and the target plane as the included angle between the pupil and the electronic device.

8. The electronic device according to claim 7, wherein the at least one processor calculates the second distance by:
determining a third position closest to the first position on the target plane;
determining a second connection line according to the first position and the third position; and
calculating a length of the second connection line according to the included angle and the first distance, and determining the length of the second connection line as the second distance between the waveguide sheet and the pupil.

9. The electronic device according to claim 6, wherein the at least one processor determines the first position by:
capturing an eye image of the user; and
determining the first position where the pupil is located based on the eye image.

10. The electronic device according to claim 6, wherein the at least one processor measures the first distance by:
measuring the first distance based on ultrasonic waves.

11. A non-transitory storage medium having stored thereon at least one computer-readable instructions, which when executed by a processor of an electronic device, causes the processor to perform a distance measurement method, wherein the method comprises:
in response to a distance detection instruction, determining a first position where a pupil of a user is located;
determining an included angle between the pupil and the electronic device based on the first position and a second position where the electronic device is located;
measuring a first distance between the pupil and the electronic device; and
calculating a second distance between a waveguide sheet in a pair of smart glasses worn by the user and the pupil according to the included angle and the first distance.

12. The non-transitory storage medium according to claim 11, wherein the determining of the included angle comprises:
determining a first connection line according to the first position and the second position;
determining a target plane according to a plane where the waveguide sheet is located and the second position, wherein the plane where the waveguide sheet is located is parallel to the target plane and the second position is located on the target plane; and
determining an included angle between the first connection line and the target plane as the included angle between the pupil and the electronic device.

13. The non-transitory storage medium according to claim 12, wherein the calculating of the second distance comprises:
determining a third position closest to the first position on the target plane; and
determining a second connection line according to the first position and the third position;
calculating a length of the second connection line according to the included angle and the first distance, and determining the length of the second connection line as the second distance between the waveguide sheet and the pupil.

14. The non-transitory storage medium according to claim 11, wherein the determining of the first position comprises:
capturing an eye image of the user; and
determining the first position there the pupil is located based on the eye image.

15. The non-transitory storage medium according to claim 11, wherein the measuring of the first distance comprises:
measuring the first distance based on ultrasonic waves.
